(19) United States
(12) Patent Application Publication
(10) Pub. No.: US 2019/0278036 A1
(43) Pub. Date: Sep. 12, 2019

(54) EMBEDDED HERMETIC CAPSULE AND METHOD

(71) Applicant: Lightwave Logic Inc., Longmont, CO (US)

(72) Inventor: Michael Lebby, San Francisco, CA (US)

(73) Assignee: Lightwave Logic Inc., Longmont, CO (US)

(21) Appl. No.: 15/914,946

(22) Filed: Mar. 7, 2018

(51) Int. Cl. G02B 6/42

(52) U.S. Cl. CPC G02B 6/4253

(57) ABSTRACT

An embedded hermetic capsule including a semiconductor/metal base with sensitive semiconductor/polymer electrical and optical components formed thereon and a semiconductor/metal embedded lid. The semiconductor/metal embedded lid sealed to the semiconductor/metal base by metallization so as to form a chamber including at least one of the sensitive semiconductor/polymer electrical and optical components and hermetically sealing the chamber and all sensitive components from the ambient in an embedded hermetic capsule. External access to the sensitive semiconductor/polymer electrical and optical components is provided through the metallization.

### FIELD OF THE INVENTION

This invention relates to basic hermetically sealed capsules encasing embedded hermetically sealed capsules hermetically sealing one or more components such as semiconductor/polymer chips and electro-optical components integrated on a common platform.

### BACKGROUND OF THE INVENTION

Polymer modulators driven by semiconductor lasers are a popular apparatus for modulating a light beam. In a copending application entitled “Polymer Modulator and Laser Integrated on a Common Platform and Method”, filed Aug. 31, 2017, with application Ser. No. 15/692,080, and incorporated herein by reference, the modulator and laser are integrated on a common platform, such as an InP chip or substrate.

A major problem that is present in the manufacture of such integrated circuits is that the semiconductor and polymer components will degrade or even fail when subjected to the moisture and gasses in the atmosphere. Prior art sealing methods generally include encapsulating the circuits in material that can be deposited over the entire circuit, such as silicon nitride, polymers, sol gels, “glob top” processing techniques or the like. This procedure introduces more problems in that the deposition generally requires high enough temperatures to damage the components. Also, it can be difficult to provide electrical contacts through the encapsulation and to provide optical pathways to allow optical communication through the encapsulation. Generally, attempts to reduce the encapsulation to allow electrical and optical communication, degrades the seal so that it is no longer hermetic, thereby causing eventual failure of the components, for example, through moisture ingress.

It would be highly advantageous, therefore, to remedy the foregoing and other deficiencies inherent in the prior art.

Accordingly, it is an object of the present invention to provide a new and improved embedded hermetic capsule sealing electrical and/or optical components on a common platform, which is in turn hermetically sealed by a basic hermetically sealed capsule.

It is another object of the present invention to provide a new and improved embedded hermetic capsule sealing one or more semiconductor lasers and polymer modulators integrated on a common platform, which is in turn hermetically sealed by a basic hermetically sealed capsule.

It is another object of the present invention to provide a new and improved embedded hermetic capsule and basic hermetic capsule provided in a wafer scale solution that is cost effective.

### SUMMARY OF THE INVENTION

Briefly to achieve the desired objects and advantages of the instant invention in accordance with a preferred embodiment an embedded hermetic capsule is provided including a semiconductor/metal base having sensitive semiconductor/polymer electrical and optical components formed thereon and a semiconductor/metal embedded lid. The semiconductor/metal embedded lid is sealed to the semiconductor/metal base by metallization so as to form a chamber including at least one of the sensitive semiconductor/polymer electrical and optical components and hermetically sealing the chamber and the at least one sensitive component from the ambient in an embedded hermetic capsule. A basic hermetic capsule surrounds and hermetically seals the sensitive semiconductor/polymer electrical and optical components including the embedded hermetic capsule.

To further achieve the desired objects and advantages of the present invention a specific embodiment of an embedded hermetic capsule includes a semiconductor/metal base having sensitive semiconductor/polymer electrical and optical components formed therein. The base is fabricated on a first wafer of InP, GaAs, GaN, sapphire, or any combinations thereof. A semiconductor/metal embedded lid is fabricated on a second wafer of the same material on which the base is fabricated, the lid further being fabricated in a shell-like form defining an internal volume surrounded by a peripheral edge. First metallization on the peripheral edges of the embedded lid and on mating peripheral areas of the base surrounds at least one of the sensitive semiconductor/polymer electrical and optical components. The semiconductor/metal embedded lid is sealed to the semiconductor/metal base by the first metallization so as to form a chamber including the at least one sensitive semiconductor/polymer electrical and optical component and hermetically sealing the chamber and the at least one sensitive semiconductor/polymer electrical and optical component in an embedded hermetic capsule. A semiconductor/metal basic lid is fabricated on a third wafer of the same material on which the base is fabricated, the basic lid further being fabricated in a shell-like form defining an internal volume surrounded by a peripheral edge. Second metallization on the peripheral edges of the basic lid and on mating peripheral areas of the base surrounds the sensitive semiconductor/polymer electrical and optical components. The second metallization seals the semiconductor/metal lid to the semiconductor/metal base in a basic hermetic capsule encapsulating the sensitive semiconductor/polymer electrical and optical components. The basic hermetic capsule defines an optical pathway coupling an optical fiber connection to an optical component sealed within the chamber.

To further achieve the desired objects and advantages of the present invention a specific embodiment of a method of fabricating an embedded hermetic capsule includes the steps of providing a first semiconductor/metal wafer, fabricating sensitive semiconductor/polymer electrical and optical components in the first semiconductor/metal wafer defining a semiconductor/metal base, fabricating a semiconductor/metal embedded lid in a shell-like form providing edges defining a volume space within the edges, and hermetically sealing the edges of the semiconductor/metal embedded lid to the semiconductor/metal base by metallization so as to form a first chamber including at least one of the sensitive semiconductor/polymer electrical and optical components. The embedded lid and base defining an embedded hermetic capsule hermetically sealing the at least one sensitive semiconductor/polymer electrical and optical component from the ambient. The method further includes the steps of fabricating a semiconductor/metal basic lid in a shell-like form providing edges defining a volume space within the edges, and hermetically sealing the edges of the semiconductor/metal basic lid to the semiconductor/metal base by metallization so as to form a second chamber including the sensitive semiconductor/polymer electrical and optical components and the embedded hermetic capsule. The basic lid and base defining a basic hermetic capsule hermetically sealing the sensitive semiconductor/polymer electrical and optical components and the embedded hermetic capsule from the ambient.

### BRIEF DESCRIPTION OF THE DRAWINGS

Specific objects and advantages of the invention will become readily apparent to those skilled in the art from the following detailed description of a preferred embodiment thereof, taken in conjunction with the drawings in which:

FIG. 1 is a perspective view of a basic hermetic capsule (in an open configuration to illustrate internal components) with integrated laser/polymer modulator;

FIG. 1A is a perspective view of embedded hermetic capsules within a basic hermetic capsule (all in an open configuration to illustrate internal components) with integrated laser/polymer modulator, according to the present invention;

FIG. 2 is a perspective view of the lid of either an embedded hermetic capsule or a basic hermetic capsule (depending upon the size) of FIG. 1, according to the present invention;

FIG. 3A through FIG. 3C illustrate several steps in a process for fabricating the lid of FIG. 2;

FIG. 4A through FIG. 4M illustrate steps in the process of fabricating an embodiment of the embedded hermetic capsule within a basic hermetic capsule of FIG. 1A, according to the present invention;

FIG. 5A through FIG. 5C illustrate steps in the process of fabricating a modification of the embedded hermetic capsule within a basic hermetic capsule of FIG. 1A, according to the present invention;

FIG. 6 illustrates another modification of the embedded hermetic capsule within a basic hermetic capsule of FIG. 1A, according to the present invention;

FIG. 7A through FIG. 7C illustrate steps in the process of fabricating another modification of the embedded hermetic capsule within a basic hermetic capsule of FIG. 1A, according to the present invention;

FIG. 8A through FIG. 8D illustrate steps in the process of fabricating another modification of the embedded hermetic capsule within a basic hermetic capsule of FIG. 1A, according to the present invention;

FIG. 9 illustrates another modification of the embedded hermetic capsule within a basic hermetic capsule of FIG. 1A, according to the present invention; and

FIG. 10 illustrates another modification of the embedded hermetic capsule within a basic hermetic capsule of FIG. 1A, according to the present invention.

### DETAILED DESCRIPTION OF THE DRAWINGS

A primary object of the present invention is to provide hermetically sealed capsules for sensitive laser and polymer modulators integrated on a common platform, although other uses are contemplated. An example of such components is the monolithic photonic integrated circuits described in copending patent application entitled “POLYMER MODULATOR AND LASER INTEGRATED ON A COMMON PLATFORM AND METHOD”, filed Aug. 31, 2017, Ser. No. 15/692,080, and incorporated herein by reference. In this specific example, the common platform is single crystal InP, because lasers are naturally fabricated from InP and are already monolithic (part of the same material). It will be understood however, that the common platform could be InP, GaAs, GaN, sapphire, or any combinations thereof. Also, while the laser described herein is generally InP, it will be understood that the lasers could be GaAs, GaN, etc. As will also be understood from the following description, the modulators in this specific example are polymer based. Further, the optical connection between the laser and modulator, in this specific example, is either polymer waveguides, or semiconductor material waveguides matching the laser (i.e. InP waveguide with InP laser). Also, the optical connecting waveguides could be dielectric based, such as silicon dioxide, silicon nitride, etc.)

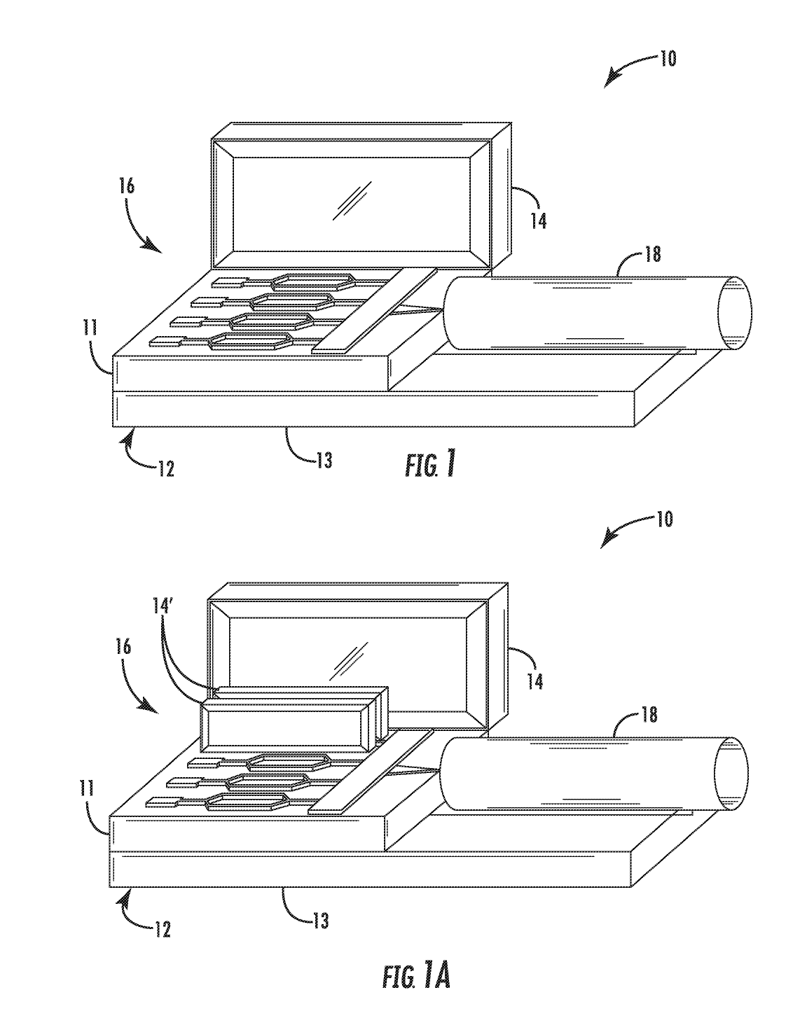

Turning to FIG. 1, a basic hermetic capsule 10, including base 12 and basic lid 14, is illustrated with integrated laser/polymer modulator 16 and optical fiber 18 optically coupled to integrated laser/polymer modulator 16 to supply an optical output. For purposes of this disclosure, basic lid 14 is defined as a “basic lid” constructed to hermetically enclose all or substantially all of integrated laser/polymer modulator 16 and the combination of basic lid 14 and the hermetically sealed circuitry is defined as a “basic embedded capsule”. Referring additionally to FIG. 1A, one or more smaller lids 14′ are constructed to hermetically seal components of integrated laser/polymer modulator 16. For purposes of this disclosure, lid 14′ is defined as an “embedded lid” and the combination of embedded lid 14′ and the hermetically sealed component or components is defined as an “embedded hermetic capsule”. Embedded lids 14′ and basic lid 14 are illustrated in an open configuration to show integrated laser/polymer modulator 16 and the coupling of optical fiber 18.

In this disclosure, the “base” is defined as the structure carrying all of the electro-optic components, and is generally illustrated and discussed as a single platform. However, it will be understood that the base could be fabricated in a semiconductor/metal wafer, designated 11 in FIGS. 1 and 1A, which could in turn be mounted on a capsule platform, designated 13, in FIGS. 1 and 1A. Capsule platform 13 could be fabricated from silicon, GaAs, metal, plastic, or any other suitable organic or inorganic material which would serve to hold the semiconductor/metal wafer and optical fiber 18 in a fixed relationship. In applications where the base is mounted on a capsule platform, as illustrated in FIGS. 1 and 1A, some of the etching steps defining the right-hand edge of the base, described below, may not be needed.

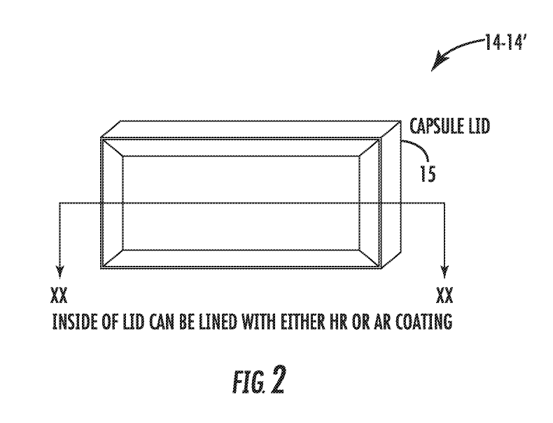

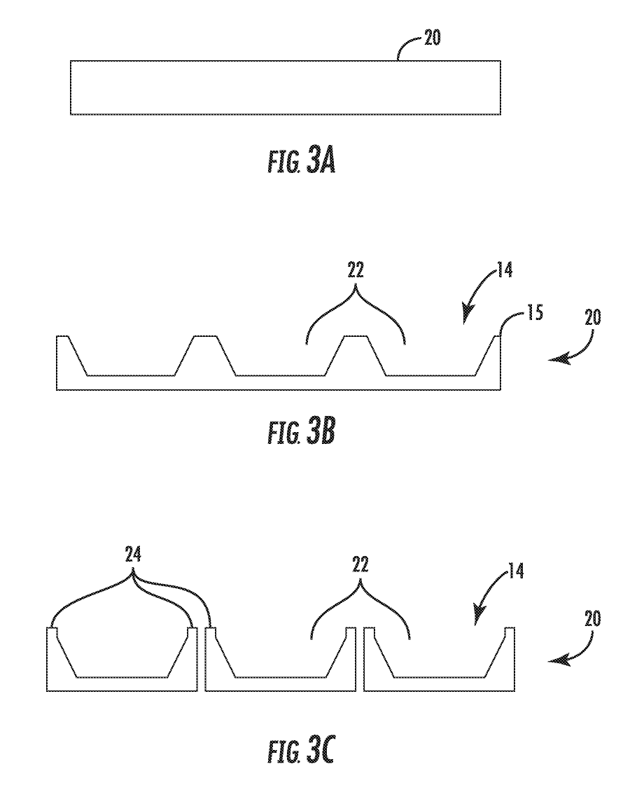

Referring to FIG. 2, lid 14 or lid 14′, depending upon the size, is illustrated individually to better show fabrication steps illustrated in FIG. 3a through 3C. In the preferred embodiment, lids 14 and 14′ are fabricated from the same material as base 12 and in a shell-like form to define an internal volume surrounded by a peripheral edge 15. For example, base 12 is fabricated from InP so that the laser can be fabricated monolithically (i.e. on the same wafer), as described in more detail in the above described copending patent application. Further, since base 12 and lids 14 and 14′ are formed of the same material, in the preferred embodiment, the coefficient of temperature expansion (CTE) will be the same. It should be understood, however, that other wafer materials, such as GaAs, GaN, silicon, sapphire, etc., could be used to fabricate base 12 and lids 14 and 14′ and in some cases, depending upon the CTE, base 12 and lids 14 and 14′ might be made of different material, to reduce cost or for other reasons. Additionally, lids 14 and 14′ can have varied shapes such as circular, elliptical or otherwise.

Referring additionally to FIGS. 3A, 3b, and 3C, some steps in a process of fabricating lids 14 and 14′ are illustrated. FIG. 3A illustrates a wafer 20 of the material selected for lids 14 and 14′. In the process, as illustrated specifically in FIG. 3B, wafer 20 is masked, photolithographed and deep trenches 22 are etched in a two-dimensional format. Well-known wet and dry etching techniques can be used. In this fashion, an array of two-dimensional trenches 22 are formed across wafer 20. As will be understood by those skilled in the art, each trench 22 defines a lid 14 or 14′ hollowed out (shell-like form) to provide a volume space within the confines of edge 15. The edges 15 of each trench 22 are metallized, designated by number 24, and the array of trenches 22 is singulated into individual lids 14 or 14′, as illustrated in FIG. 3C. In addition to providing hermetic sealing of lids 14 and 14′ to base 12, the metallization can be used for internal protection, lid lining, reflector applications, or could be a non-reflective lining for absorption of stray light and the like. In addition to or instead of metallization of the inside of each lid 14 or 14′, the inside can be lined with either a high reflective (HR) or an antireflective (AR) coating.

In the specific example illustrated in FIG. 3C lids 14 or 14′ are singulated before attachment to corresponding bases 12. However, in some applications it may be more convenient to align and then simultaneously bond multiple lids 14 or 14′ still connected by the continuous material (e.g. as illustrated in FIG. 3B) to corresponding bases 12 (also formed in a matching array on a second wafer). The bonded bases/lids could then be singulated into individual components.

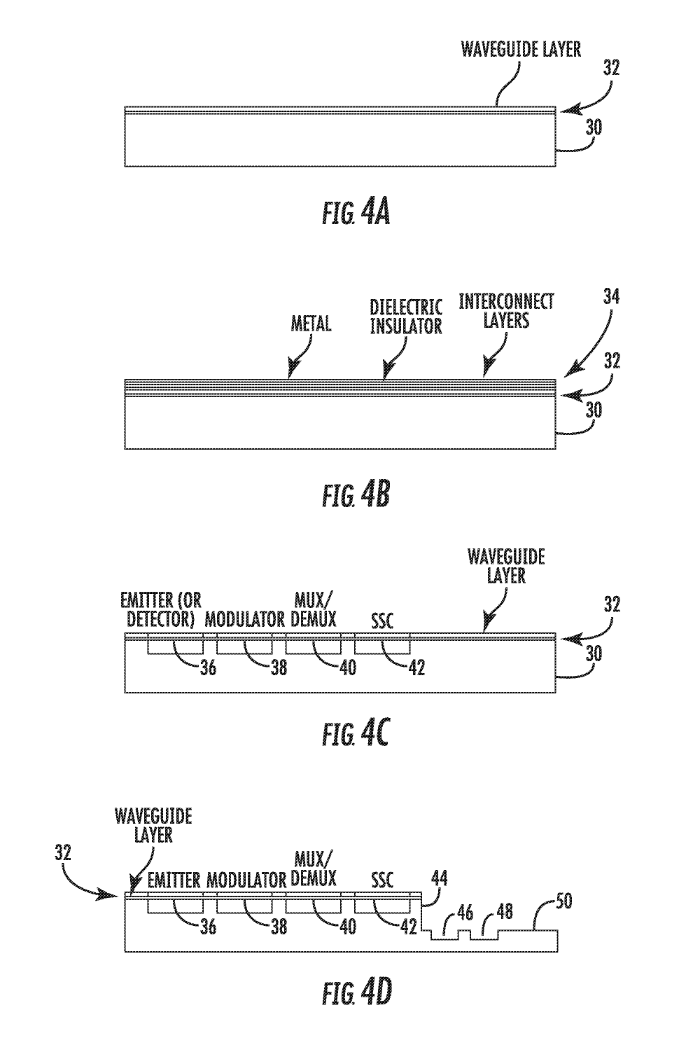

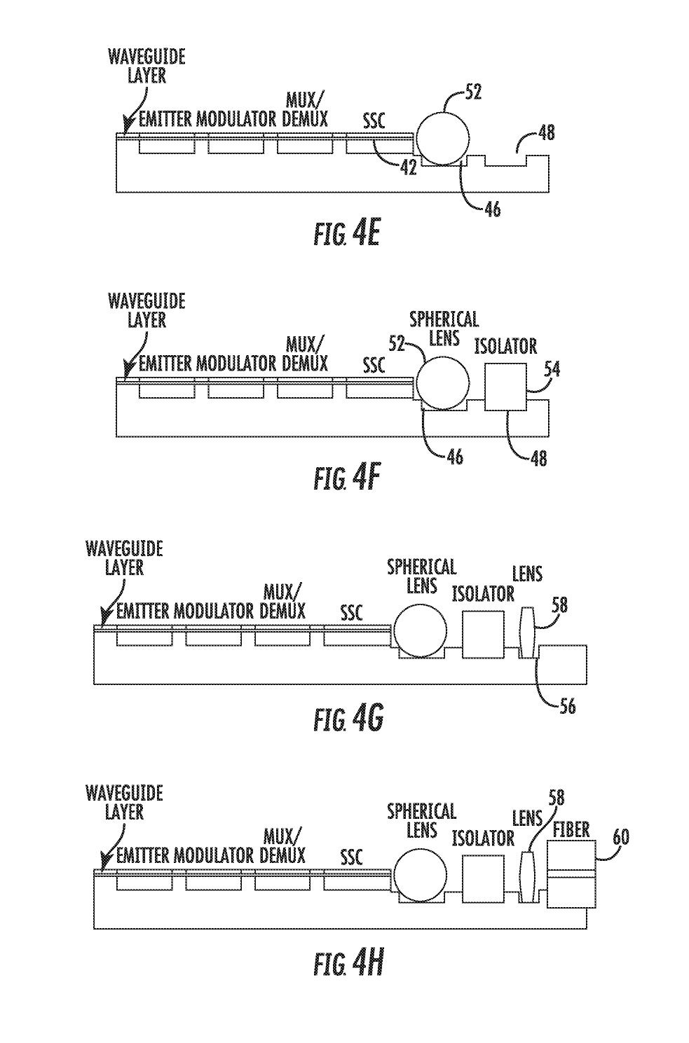

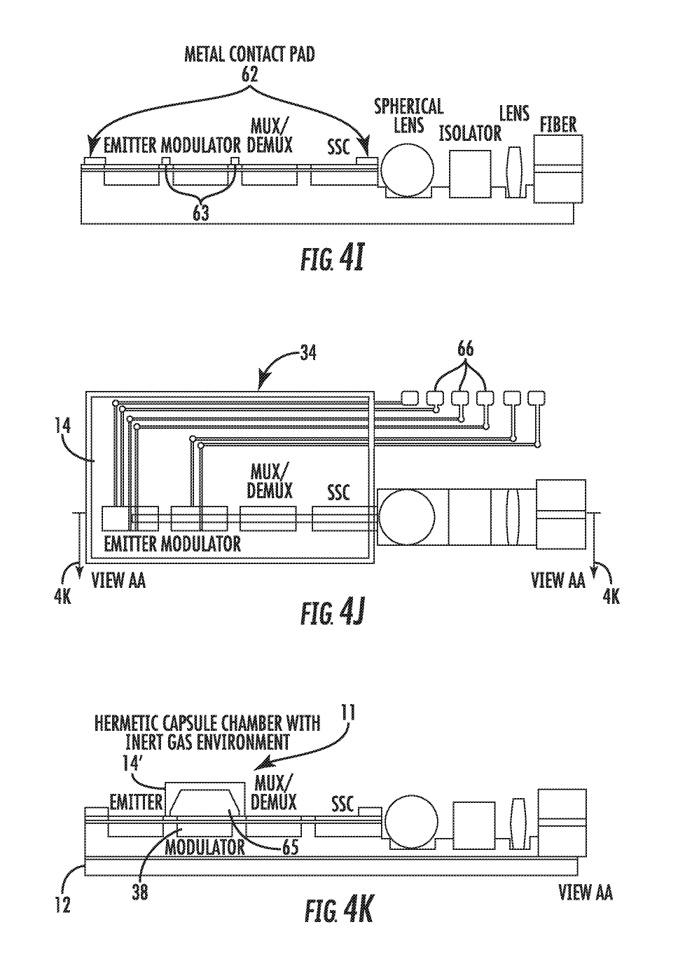

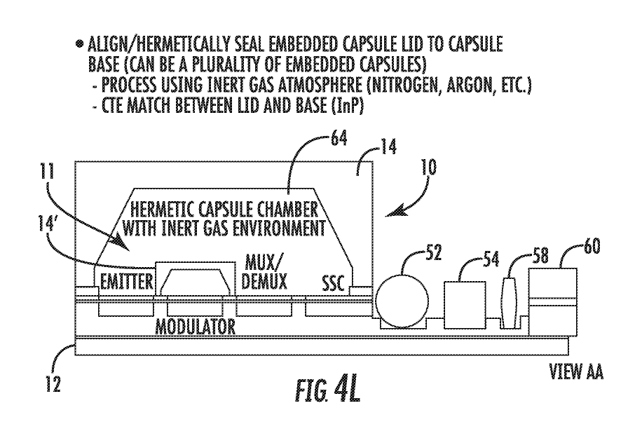

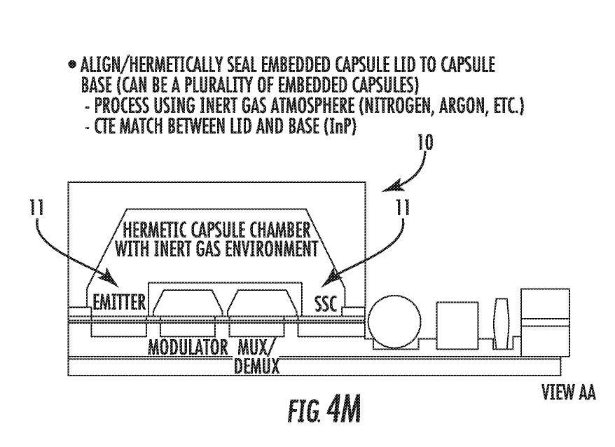

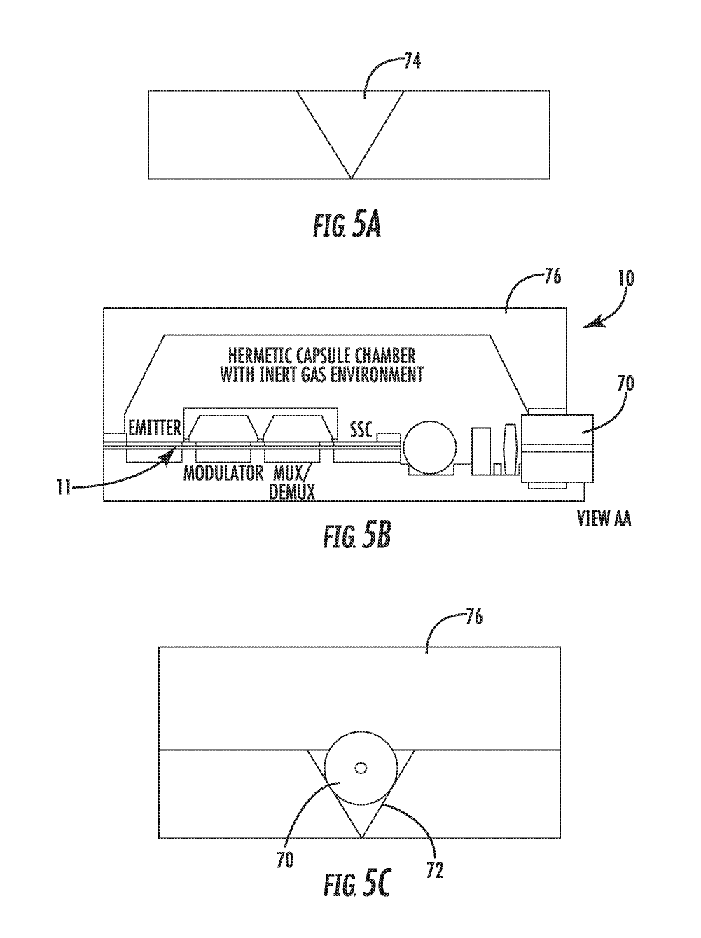

Turning now to FIG. 4A through FIG. 4M, steps for fabricating base 12, including integrated laser/polymer modulator 16 and optical fiber 18 optically coupled to integrated laser/polymer modulator 16, are illustrated. While a single base 12 is illustrated for convenience of the viewer, it should be understood that an array of bases similar to that illustrated could be formed in a wafer so as to be aligned with the array of lids illustrated in FIG. 3B. To this end, FIG. 4A through FIG. 4M, can be considered to illustrate a single one of an array of bases. Referring specifically to FIG. 4A, a semiconductor wafer 30 is provided. Wafer 30 includes InP in the preferred embodiment because a laser diode can be fabricated monolithically as a source of light for the structure. The wafer can include GaAs, GaN, silicon, etc. In the case of GaAs and GaN, monolithic emitters (lasers or LEDs) can be formed monolithically but in the case of a silicon wafer, InP, GaAs, or GaN would be grown or bonded on the silicon wafer to provide for a monolithic emitter. With further reference to FIG. 4A, semiconductor wafer 30 is modified by the growth of epi layers 32 to define laser/waveguide structures. Some laser/waveguide structures that might be formed include, for example, quantum wells, waveguide cladding layers, highly and lightly doped N and P layers, waveguide barrier layers, etc. Many or all of these structures might include InP material systems, such as InGaAs, InGaP, InGaAlAs, InGaAlP, InAsGaP, etc.

Referring specifically to FIG. 4B, semiconductor wafer 30 is further modified by depositing multiple layers of metal/dielectric material to define electrical interconnect layers 34 at the upper surface. Electrical interconnect layers 34 allow electrical signaling (e.g. rf, microwave, ac, dc, etc.) to pass between the integrated devices (see below) and the exterior for bonding and signaling.

Referring specifically to FIG. 4C, photonic devices are fabricated into epi layers 32. In this preferred embodiment the photonic devices can include any or all of an emitter/detector 36, a modulator 38, a mux/demux device 40, and spot size converter 42. Also, emitter/detector 36, in the emitter form, preferably includes a laser, such as a distributed feedback (DFB) laser, a Fabry-Perot (FB) laser, a distributed Bragg reflector (DBR) laser, a tunable laser, a VCSEL (vertical cavity surface emitting laser), an external cavity laser or any other type of semiconductor laser. Emitter/detector 36, in the detector form, preferably includes semiconductor diodes of the n-p, n-i-p, type or the like, which can be easily fabricated in the semiconductor/metal base. While the major components are listed above, the photonic devices can also include other components, such as modulators, detectors, mux, demux, waveguides, couplers, splitters, and spot size converters all in InP (in the preferred example). The modulator and at least some of the waveguide can be polymer based, e.g. a Mach-Zehnder structure.

Referring specifically to FIG. 4D, semiconductor wafer 30 is fabricated for optical fiber alignment/placement and to allow for mounting of a spherical lens and/or an isolator. In this embodiment, this is accomplished by etching semiconductor wafer 30 (at the right hand side in the figures) to expose the end 44 of spot size converter 42 and to form depressions 46 and 48 and an elongated V-shaped trench 50 for receiving an optical fiber therein. Referring additionally to FIG. 4E, a spherical lens 52 is fixedly mounted in depression 46 so as to be optically and mechanically aligned with spot size converter 42. Referring additionally to FIG. 4F, an optical isolator 54 is fixedly mounted in depression 48 so as to be optically aligned with spherical lens 52. Optical isolator 54 allows optical signals to be collimated and aligned for delivery to an optical fiber.

Referring additionally to FIG. 4G, an additional depression 56 is formed/etched adjacent the right-hand end of semiconductor wafer 30 and an optical lens 58 is fixedly mounted therein in optical alignment with optical isolator 54. Optical lens 58 is designed to focus light to/from an optical fiber and allows optical signals to be more accurately aligned to an optical fiber. Referring additionally to FIG. 4H, one end of an optical fiber 60 is fixedly mounted in elongated V-shaped trench 50 so as to be optically aligned with optical lens 58. It will be understood that any or all of spherical lens 52, optical isolator 54, and optical lens 58 may or may not be included in any specific structure, depending upon application and other engineering factors (e.g. materials used, alignment required, etc.).

Turning to FIG. 41, the structure of FIG. 4H is illustrated with metal contact pad 62 formed on the entire peripheral area (mating with edge 15 of lid 14), including spot size converter 42, so as to completely surround all of the photonic devices, including all of emitter/detector 36, modulator 38, mux/demux device 40, and all or nearly all of spot size converter 42. At this point contact pads 63 can also be formed to completely surround one or more components, in this example modulator 38. Metallization of contact areas (or area) 62 and 63 is preferably performed by using evaporation, ebeam, or sputtering of the metal onto the designated surface. Referring additionally to FIG. 4K, lid 14′ (as metalized in FIG. 3C) is aligned and hermetically sealed to base 12 to encapsulate and hermetically seal modulator 38. A chamber 65 formed by the union of base 12 and lid 14′ is preferably filled with an inert gas (e.g. nitrogen, argon, etc.) which can be introduced by aligning and sealing lid 14′ in an atmosphere of the chosen inert gas. Thus, an embedded hermetic capsule, designated 11, is formed to include modulator 38.

Referring additionally to FIG. 4L, lid 14 (as metalized in FIG. 3C) is aligned and hermetically sealed to base 12 to encapsulate and hermetically seal all of the sensitive semiconductor/polymer components. In this context, the term “sensitive” is defined to include any components formed of material that can be affected by the ambient (e.g. semiconductor and polymer components) while standard components of glass, etc, (e.g. spherical lens 52, isolator 54, optical lens 58, and optical fiber 60) are not sensitive and are generally not encapsulated. The metalized sealing (of both lids 14′ and 14) can be accomplished, for example, via laser, seam, bonding, alloying, etc. A chamber 64 formed by the union of base 12 and lid 14 is preferably filled with an inert gas (e.g. nitrogen, argon, etc.) which can be introduced by aligning and sealing lid 14 in an atmosphere of the chosen inert gas. Thus, basic hermetic capsule, 10 is formed around all of the sensitive semiconductor/polymer components, as well as embedded hermetical capsule 11 formed to include modulator 38.

The combination of embedded hermetic capsule 11 and basic hermetic capsule 10 provide additional protection for sensitive devices and especially sensitive polymers from the environment. The combination of embedded hermetic capsule 11 and basic hermetic capsule 10 also allow for any potential leaks in the basic hermetic capsule. Embedded hermetic capsule 11 is designed not to affect the component covered, in this example modulator 38, but the component hermetically sealed could be laser 36 plus modulator 38, modulator 38 plus waveguide, mux/demux 40, and various combinations of components included in the circuitry. Also, as illustrated in FIG. 4M, more than one embedded hermetic capsule 11 may be included within basic hermetic capsule 10.

Referring again to FIG. 4J, the position of electrical interconnect layers 34 and the various optical components are illustrated in a top view of basic hermetic capsule 10 (even though they would be hidden by basic lid 14 and overlying material) to illustrate externally accessible electrical contacts or contact pads 66 and their connections to the electrical portions of emitter/detector 36 and modulator 38. The electrical lines formed in electrical interconnect layer 34 are buried in an insulating oxide or polymer layer or layers to avoid current leakage between adjacent lines and to avoid shorting to the metallization seals of both basic lid 14 and embedded lid 14′. Thus, it can be seen that embedded hermetic capsule 11 hermetically encapsulates one or more components and basic hermetic capsule 10 hermetically encapsulates all of the various semiconductor/polymer components while allowing external electrical and optical access. In this specific embodiment, the metallization in area 62, along with spot size converter 42 defines an optical output pathway for connection to an external device, such as an optical fiber. The electrical interconnect layers 34 and externally accessible electrical contacts or contact pads 64 are applicable to all embodiments and capsule designs.

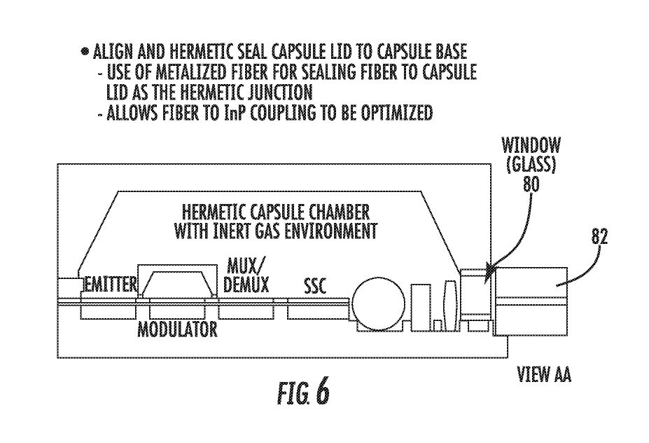

Turning to FIG.5A, FIG. 5B, and FIG. 5C, a modification of the basic hermetic capsule 10 and embedded hermetic capsules 11 illustrated in FIG. 4M, is illustrated. In this modified structure, a metallized optical fiber 70 is positioned in a V-shaped groove 74 (see FIG. 5A). Metallized optical fiber 70 has an outer metal coating 72 (see FIG. 5C) for at least the portion lying in V-shaped groove 74. A lid 76, which is modified to extend to the right-hand edge (see FIG. 5B) is metallized, generally as explained above, and hermetically seals fiber 70 into the side of the hermetic capsule. This modified basic hermetic capsule allows the optical fiber-to-InP components to be optimized. Other than the modified lid and optical fiber, the structure remains the same as described above, with one other exception, the lid is also modified to allow external electrical connections (contact pads 66) to be accessed.

Turning to FIG. 6, another modification of the basic hermetic capsule is illustrated. In this structure, the base and lid are the same as illustrated in FIG. 5B but instead of enclosing a metalized optical fiber a window 80 is metalized and sealed in the right hand wall adjacent the right hand edge of the base. An optical fiber 82 is mounted in a V-groove at the right-hand edge of the base and aligned to receive optical signals from the internal optics through window 80. Window 80 can be glass or any optically transparent material that preserves the hermetic seal.

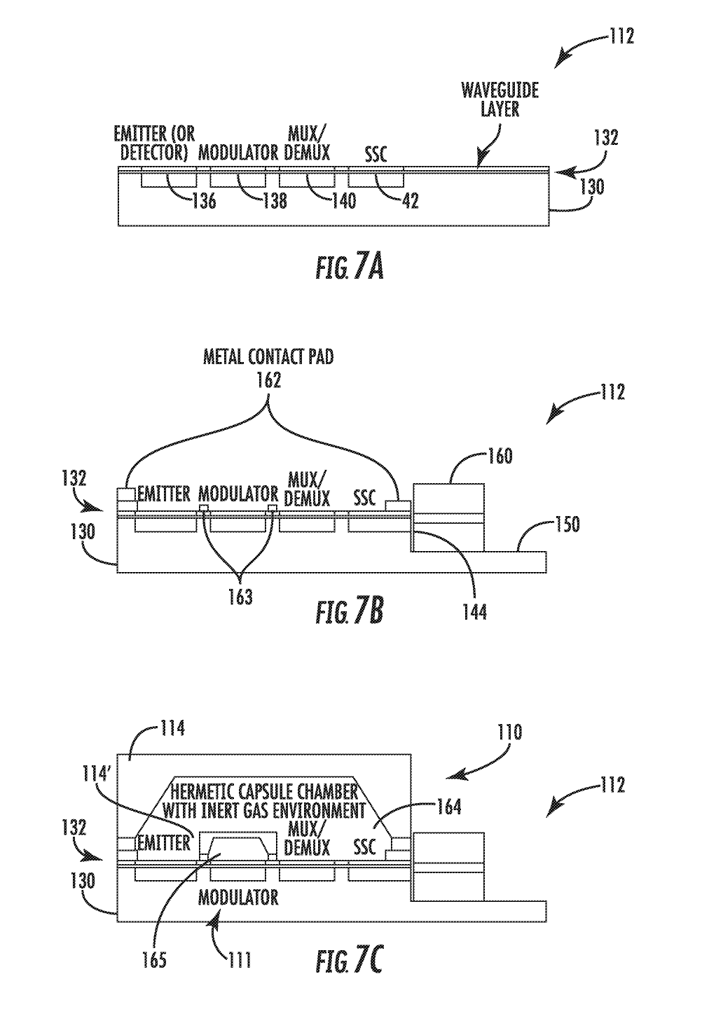

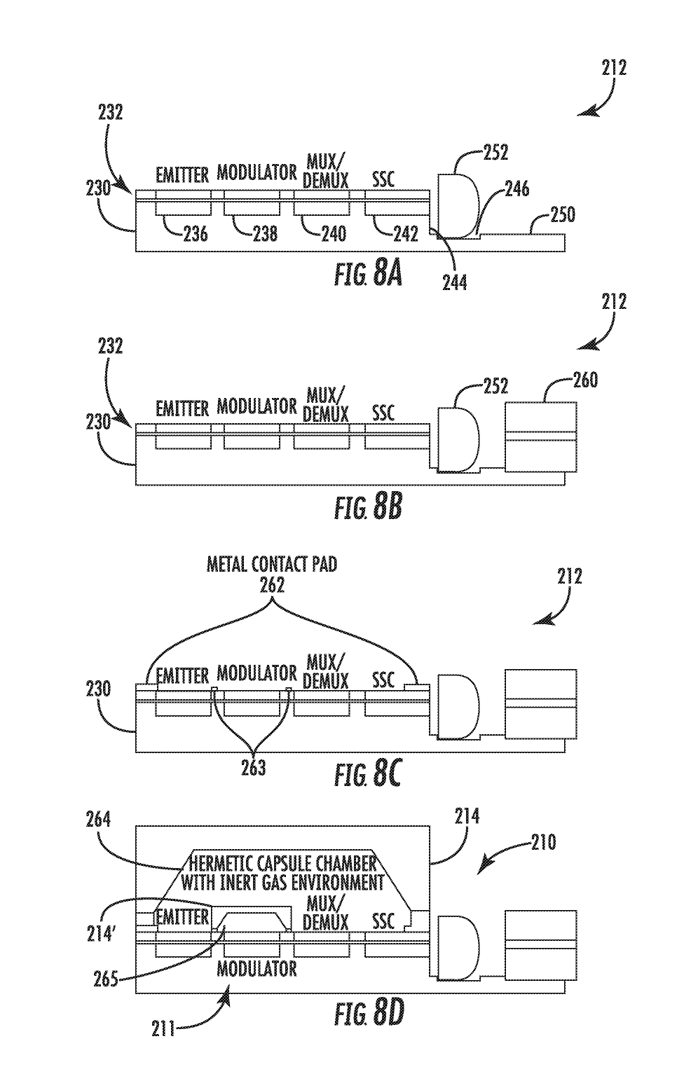

Referring to FIG. 7A, FIG. 7B, and FIG. 7C, a simplified modification is illustrated, which can be used in some specific applications. In this example, steps for fabricating a base 112, include providing a semiconductor wafer 130 and modifying base 112 by the growth of epi layers 132 to define laser/waveguide structures similar to that described in FIG. 4A above. Referring specifically to FIG. 7A, photonic devices are fabricated into epi layers 132. In this preferred embodiment, the photonic devices can include any or all of an emitter/detector 136, a modulator 138, a mux/demux device 140, and spot size converter 142. Also, emitter/detector 136, in the emitter form, preferably includes a laser, such as a distributed feedback (DFB) laser, a Fabry-Perot (FB) laser, a distributed Bragg reflector (DBR) laser, a tunable laser, a VCSEL (vertical cavity surface emitting laser), or any other type of semiconductor laser. While the major components are listed above, the photonic devices can also include other components, such as modulators, detectors, mux, demux, waveguides, couplers, splitters, and spot size converters all in InP (in the preferred example). The modulator and at least some of the waveguide can be polymer based, e.g. a Mach-Zehnder structure.

Referring specifically to FIG. 7B another step in the process includes etching semiconductor wafer 130 (at the right-hand side in FIG. 7B) to expose an end 144 of spot size converter 142 and to form an elongated V-shaped trench 150 for receiving an optical fiber 160 therein. In this modification, spherical lens 52, isolator 54, and lens 58 (see FIG. 4H) are not used and optical fiber 160 is butted directly against and optically aligned with end 144 of spot size converter 142. Metal contact pad 162 is formed on the peripheral area, including spot size converter 142, so as to completely surround all of the photonic devices, including all of emitter/detector 136, modulator 138, mux/demux device 140, and all or substantially all of spot size converter 142. At this point contact pads 163 can also be formed to completely surround one or more components, in this example modulator 138.

Metallization of contact areas 162 and 163 is preferably performed by using evaporation, ebeam, or sputtering of the metal onto the designated surface. Referring additionally to FIG. 7C, lid 114′ (as metalized in FIG. 3C) is aligned and hermetically sealed to base 112 to encapsulate and hermetically seal modulator 138 to form embedded hermetic capsule 111. Lid 114 (as metalized in FIG. 3C) is aligned and hermetically sealed to base 112 to encapsulate and hermetically seal all of the semiconductor/polymer components, as well as embedded hermetic capsule 111 to form basic hermetic capsule 110. The metalized sealing can be accomplished, for example, via laser, seam, bonding, alloying, etc. A chamber 165 formed by the union of lid 114′ and base 112 and a chamber 164 formed by the union of base 112 and lid 114 are preferably filled with an inert gas (e.g. nitrogen, argon, etc.) which can be introduced by aligning and sealing lids 114′ and 114, individually in an atmosphere of the chosen inert gas.

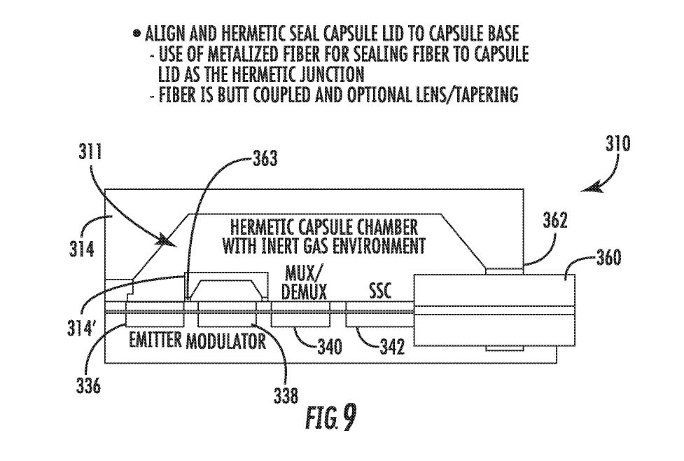

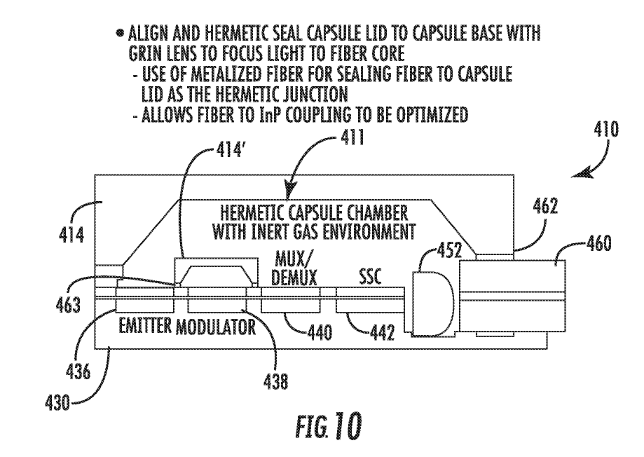

Referring to FIG. 8A, FIG. 8B, FIG. 8C, and FIG. 8D, another modification is illustrated, which can be used in some specific applications. In this example, steps for fabricating a base 212, include providing a semiconductor wafer 230 and modifying base 212 by the growth of epi layers 232 to define laser/waveguide structures similar to that described in FIG. 4A above. Referring specifically to FIG. 8A, photonic devices are fabricated into epi layers 232. In this preferred embodiment, the photonic devices can include any or all of an emitter/detector 236, a modulator 238, a mux/demux device 240, and spot size converter 242. Also, emitter/detector 236, in the emitter form, preferably includes a laser, such as a distributed feedback (DFB) laser, a Fabry-Perot (FB) laser, a distributed Bragg reflector (DBR) laser, a tunable laser, a VCSEL (vertical cavity surface emitting laser), or any other type of semiconductor laser. While the major components are listed above, the photonic devices can also include other components, such as modulators, detectors, mux, demux, waveguides, couplers, splitters, and spot size converters all in InP (in the preferred example). The modulator and at least some of the waveguide can be polymer based, e.g. a Mach-Zehnder structure.

Still referring to FIG. 8A, another step in the process includes etching semiconductor wafer 230 (at the right-hand side in FIG. 8A) to expose an end 244 of spot size converter 242 and to form depression 246 and to form an elongated V-shaped trench 250 for receiving an optical fiber 260 therein. In this modification, spherical lens 52, isolator 54, and lens 58 (see FIG. 4H) are not used and an optical focusing lens 252 (in the preferred example a GRIN type lens) is fixedly engaged in depression 246 and optically aligned with the output/input of spot size converter 242. As illustrated specifically in FIG. 8B, optical fiber 260 is engaged in V-shaped groove 250 and optically aligned with optical focusing lens 252.

Referring specifically to FIG. 8C, metal contact pad 262 is formed on the peripheral area, including spot size converter 242, so as to completely surround all of the photonic devices, including all of emitter/detector 236, modulator 238, mux/demux device 240, and all or substantially all of spot size converter 242. At this point contact pads 263 can also be formed to completely surround one or more components, in this example modulator 238. Metallization of contact areas 262 and 263 are preferably performed by using evaporation, ebeam, or sputtering of the metal onto the designated surface. Referring additionally to FIG. 8D, lid 114′ (as metalized in FIG. 3C) is aligned and hermetically sealed to base 112 to encapsulate and hermetically seal modulator 238 to form embedded hermetic capsule 211. Lid 214 (as metalized in FIG. 3C) is aligned and hermetically sealed to base 212 to encapsulate and hermetically seal all of the semiconductor/polymer components to form basic hermetic capsule 210. The metalized sealing can be accomplished, for example, via laser, seam, bonding, alloying, etc. A chamber 265 formed by the union of base 212 and lid 214′ and a chamber 264 formed by the union of base 212 and lid 214 are preferably filled with an inert gas (e.g. nitrogen, argon, etc.) which can be introduced by aligning and sealing lids 214′ and 214, individually, in an atmosphere of the chosen inert gas.

A potential modification to the structure illustrated FIG. 7C, is illustrated in FIG. 9. In this modification, metal contact pad 362 is formed on the peripheral area, including optical fiber 360 (instead of spot size converter 342), so as to completely surround all of the photonic devices, including all of emitter/detector 336, modulator 338, mux/demux device 340, and spot size converter 342 and provide basic hermetic capsule 310. Also, metal contact pad 363 is formed on the peripheral area surrounding modulator 338 and lid 314′ is aligned and sealed to provide embedded hermetic capsule 311 within basic hermetic capsule 310.

A potential modification to the structure illustrated FIG. 8D, is illustrated in FIG. 10. In this modification, metal contact pad 462 is formed on the peripheral area, including optical fiber 460 (instead of spot size converter 442), so as to completely surround all of the photonic devices, including all of emitter/detector 436, modulator 438, mux/demux device 440, and spot size converter 442 and provide basic hermetic capsule 410. Also, metal contact pad 463 is formed on the peripheral area surrounding modulator 438 and lid 414′ is aligned and sealed to provide embedded hermetic capsule 411 within basic hermetic capsule 410.

In each of the above described basic and embedded hermetic capsules (including all structures/modifications), the semiconductor/metal embedded lid is sealed to the semiconductor/metal base by metallization so as to form a chamber including one or more sensitive semiconductor/polymer components and hermetically seal the sensitive components from the ambient. Also in each of the above described embedded and basic hermetic capsules (including all structures/modifications), the semiconductor/metal basic lid is sealed to the semiconductor/metal base by metallization so as to form a chamber including all sensitive semiconductor/polymer components and hermetically seal all sensitive components and the embedded hermetic capsule or capsules from the ambient. In a preferred embodiment, the embedded lid and the basic lid and base are fabricated from the same or similar material so that the coefficient of temperature expansion is not a problem. In the various modifications illustrated and described, some components are added or subtracted, as preferred in different applications, and the peripheral seal between basic lid and base is moved to provide different sealing surfaces for different applications or metallizing procedures. In all instances, the structures/modifications provide one or more embedded hermetic capsules and a basic hermetic capsule for hermetically sealing semiconductor/polymer material and especially for monolithic photonic integrated circuits (PICs) and optical components therein. In all instances, the embedded hermetic capsule and the basic hermetic capsule provide an optical pathway for optical fiber connections and high performance signaling (both electrical and optical). Further, both the base and the embedded and basic lids are fabricated on a wafer scale that is cost effective.

Thus, new and improved embedded and basic hermetic capsules for sealing electrical and /or optical components on a common platform is illustrated and disclosed. In a preferred embodiment, the embedded hermetic capsule contains and hermetically seals a laser and/or polymer modulator integrated on a common platform. The combination of embedded and basic hermetic capsules more efficiently seals sensitive components integrated on a common platform with electrical and optical coupling to the exterior. Also, fabrication of both the embedded and basic hermetic capsule is performed in a wafer scale solution that is cost effective.

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. A basic hermetic capsule encasing one or more embedded hermetic capsules comprising:
a semiconductor base including a monolithic photonic integrated circuit in the semiconductor base with a plurality of integrated sensitive semiconductor and/or polymer electrical and optical components;
a semiconductor embedded lid;
the semiconductor embedded lid sealed to the semiconductor base by metallization so as to form a chamber including at least one of the sensitive semiconductor and/or polymer electrical and optical components and hermetically sealing the chamber and the at least one of the plurality of integrated sensitive semiconductor and/or polymer electrical and optical component from the ambient in an embedded hermetic capsule; and
a basic hermetic capsule surrounding and hermetically sealing the plurality of integrated sensitive semiconductor and/or polymer electrical and optical components including the embedded hermetic capsule.

2. (canceled)

3. The basic hermetic capsule encasing one or more embedded hermetic capsules claimed in claim 1 wherein the plurality of integrated sensitive semiconductor and/or polymer electrical and optical components included in the monolithic photonic integrated circuit include one or more of an emitter, detector, a modulator, a mux, demux, and a spot size converter.

4. The basic hermetic capsule encasing one or more embedded hermetic capsules claimed in claim 1 wherein the semiconductor embedded lid is a shell-like form providing edges defining a volume space within the edges.

5. The basic hermetic capsule encasing one or more embedded hermetic capsules claimed in claim 1 wherein the semiconductor base and the semiconductor embedded lid are formed of InP, GaAs, GaN, sapphire, or any combinations thereof.

6. The basic hermetic capsule encasing one or more embedded hermetic capsules claimed in claim 5 wherein the semiconductor base and the semiconductor embedded lid are formed of the same material.

7. A basic hermetic capsule encasing one or more embedded hermetic capsules comprising:
a semiconductor base including a monolithic photonic integrated circuit in the semiconductor base with a plurality of integrated sensitive semiconductor and/or polymer electrical and optical components, the base being fabricated on a first wafer of InP, GaAs, GaN, sapphire, or any combinations thereof;
a semiconductor embedded lid fabricated on a second wafer of the same material on which the base is fabricated, the lid further being fabricated in a shell-like form defining an internal volume surrounded by a peripheral edge;
first metallization on the peripheral edge of the embedded lid and on mating peripheral areas of the base surrounding at least one of the plurality of integrated sensitive semiconductor and/or polymer electrical and optical components;
the semiconductor embedded lid sealed to the semiconductor base by the first metallization so as to form a chamber including the at least one of the plurality of integrated sensitive semiconductor and/or polymer electrical and optical components and hermetically sealing the chamber and the at least one of the plurality of integrated sensitive semiconductor and/or polymer electrical and optical components in an embedded hermetic capsule;
a semiconductor basic lid fabricated on a third wafer of the same material on which the base is fabricated, the basic lid further being fabricated in a shell-like form defining an internal volume surrounded by a peripheral edge;
second metallization on the peripheral edge of the basic lid and on mating peripheral areas of the base surrounding the plurality of integrated sensitive semiconductor and/or polymer electrical and optical components; and
the second metallization sealing the semiconductor basic lid to the semiconductor base in a basic hermetic capsule encapsulating the plurality of integrated sensitive semiconductor and/or polymer electrical and optical components and the embedded hermetic capsule, the basic hermetic capsule defining an optical pathway coupling an optical fiber connection to an optical component sealed within the chamber.

8. A method of fabricating a basic hermetic capsule encasing one or more embedded hermetic capsules comprising the steps of:
providing a first semiconductor wafer;
fabricating a monolithic photonic integrated circuit in the semiconductor wafer with a plurality of integrated sensitive semiconductor and/or polymer electrical and optical components in the first semiconductor wafer defining a semiconductor base;
fabricating a semiconductor embedded lid in a shell-like form providing edges defining a volume space within the edges;
hermetically sealing the edges of the semiconductor embedded lid to the semiconductor base by metallization so as to form a first chamber including at least one of the plurality of integrated sensitive semiconductor and/or polymer electrical and optical components, the embedded lid and base defining an embedded hermetic capsule hermetically sealing the at least one of the plurality of integrated sensitive semiconductor and/or polymer electrical and optical components from the ambient;
fabricating a semiconductor basic lid in a shell-like form providing edges defining a volume space within the edges; and
hermetically sealing the edges of the semiconductor basic lid to the semiconductor base by metallization so as to form a second chamber including the plurality of integrated sensitive semiconductor and/or polymer electrical and optical components and the embedded hermetic capsule, the basic lid and base defining a basic hermetic capsule hermetically sealing the plurality of integrated sensitive semiconductor and/or polymer electrical and optical components and the embedded hermetic capsule from the ambient.

9. A The method as claimed in claim 8 wherein the step of providing the first semiconductor wafer includes providing a wafer of one of InP, GaAs, GaN, sapphire, or any combinations thereof.

10. The method as claimed in claim 9 wherein the step of fabricating a semiconductor embedded lid in a shell-like form includes the steps of providing a second semiconductor wafer and etching a surface of the second wafer to form a hollowed out volume space within the edges.

11. The method as claimed in claim 10 wherein the step of providing the second semiconductor wafer includes providing a wafer of the same material as the first semiconductor wafer.

12. The method as claimed in claim 9 wherein the step of fabricating a semiconductor basic lid in a shell-like form includes the steps of providing a third semiconductor wafer and etching a surface of the third wafer to form a hollowed out volume space within the edges.

13. The method as claimed in claim 12 wherein the step of providing the third semiconductor wafer includes providing a wafer of the same material as the first semiconductor/metal wafer.

14. The method as claimed in claim 8 wherein the step of hermetically sealing the edges of the semiconductor embedded lid to the semiconductor base by metallization includes the steps of depositing metallization on the peripheral edges of the embedded lid and metallization on mating peripheral areas of the base and sealing the metallization on the peripheral edges of the embedded lid to the metallization on the mating peripheral areas of the base.

15. The method as claimed in claim 8 wherein the step of hermetically sealing the edges of the semiconductor basic lid to the semiconductor/metal base by metallization includes the steps of depositing metallization on the peripheral edges of the basic lid and metallization on mating peripheral areas of the base and sealing the metallization on the peripheral edges of the basic lid to the metallization on the mating peripheral areas of the base.

16. The method as claimed in claim 8 wherein the step of hermetically sealing the edges of the semiconductor embedded lid to the semiconductor base by metallization includes a step of providing first metallization on the peripheral edge of the embedded lid and on mating peripheral areas of the base surrounding at least one of the plurality of integrated sensitive semiconductor and/or polymer electrical and optical components and the step of hermetically sealing the edges of the semiconductor embedded lid to the semiconductor base by metallization includes aligning the first metallization on the peripheral edge of the embedded lid with the mating peripheral areas of the base and sealing the first metallization on the peripheral edge of the embedded lid to the mating peripheral areas of the base in an atmosphere of an inert gas.

17. (canceled)

18. The method as claimed in claim 8 wherein the step of hermetically sealing the edges of the semiconductor basic lid to the semiconductor base by metallization includes a step of providing second metallization on the peripheral edge of the basic lid and on mating peripheral areas of the base surrounding the plurality of integrated sensitive semiconductor and/or polymer electrical and optical components and the step of hermetically sealing the edges of the semiconductor basic lid to the semiconductor base by metallization includes aligning the second metallization on the peripheral edge of the basic lid with the mating peripheral areas of the base and sealing the first metallization on the peripheral edge of the basic lid to the mating peripheral areas of the base in an atmosphere of an inert gas.

19. (canceled)

20. The basic hermetic capsule encasing one or more embedded hermetic capsules claimed in claim 1 wherein the monolithic photonic integrated circuit includes a capsule platform having the semiconductor base mounted thereon and fabricated from silicon, GaAs, metal, or plastic.

21. The basic hermetic capsule encasing one or more embedded hermetic capsules claimed in claim 7 wherein at least one of the semiconductor embedded lid and the semiconductor basic lid includes metallization of an inner and/or outer surface.

22. The method as claimed in claim 8 wherein at least one of the semiconductor embedded lid and the semiconductor basic lid includes metallization of an inner and/or outer surface.
